(19) United States
(12) Patent Application Publication
(10) Pub. No.: US 2025/0305438 A1
(43) Pub. Date: Oct. 2, 2025

(54) METHOD FOR OPERATING AN INTERNAL COMBUSTION ENGINE, CONTROL UNIT FOR AN INTERNAL COMBUSTION ENGINE, AND INTERNAL COMBUSTION ENGINE

(71) Applicant: Rolls-Royce Solutions GmbH, Friedrichshafen (DE)

(72) Inventors: Armin Schwarzenbach, Langenargen (DE); Andreas Flohr, Untersiggingen (DE)

(73) Assignee: Rolls-Royce Solutions GmbH, Friedrichshafen (DE)

(21) Appl. No.: 19/233,748

(22) Filed: Jun. 10, 2025

Related U.S. Application Data
(63) Continuation of application No. PCT/EP2023/085889, filed on Dec. 14, 2023.

(30) Foreign Application Priority Data
Dec. 16, 2022 (DE) 10 2022 133 771.5
Dec. 14, 2023 (WO) PCT/EP2023/085889

(51) Int. Cl. F02B 37/14; F02B 37/10

(52) U.S. Cl. CPC F02B 37/14; F02B 37/10

(57) ABSTRACT

A method for operating an internal combustion engine includes the steps of: providing that the internal combustion engine includes a compressor, a turbine, and an electric motor, the compressor being arranged in an air path so as to compress ambient air of the internal combustion engine flowing along the air path, the turbine being arranged in an exhaust gas path and being drive-operatively connected with the compressor, the electric motor being drive-operatively connected with the compressor; collecting at least one operating parameter that is characteristic for a density of the ambient air of the internal combustion engine; and controlling the electric motor depending on the at least one operating parameter.

### CROSS REFERENCE TO RELATED APPLICATIONS

This is a continuation of PCT application no. PCT/EP2023/085889, entitled “METHOD FOR OPERATING AN INTERNAL COMBUSTION ENGINE, CONTROL UNIT FOR AN INTERNAL COMBUSTION ENGINE, AND INTERNAL COMBUSTION ENGINE”, filed Dec. 14, 2023, which is incorporated herein by reference. PCT application no. PCT/EP2023/085889 claims priority to German patent application no. 10 2022 133 771.5, filed Dec. 16, 2022, which is incorporated herein by reference.

### BACKGROUND OF THE INVENTION

### 1. Field of the Invention

The present invention relates to internal combustion engines.

### 2. Description of the Related Art

In the case of internal combustion engines, in particular gas engines, an exhaust gas turbocharger is typically provided with a turbine that is undersized with regard to the rated output of the internal combustion engine to provide boost pressure control reserve at low air density-especially because of high ambient temperatures or due to the internal engine's operating location at a geodetically high altitude—in order to regulate the speed of the internal combustion engine and to deliver the required power. This, however, results in excessive boost pressure at a majority of operating points, and in particular in over 90% of operating time, which must be adjusted by way of a pressure control device, for example a throttle valve. This adversely reduces the efficiency of the internal combustion engine. The provision of boost pressure control reserve could be achieved by way of variable turbine geometry, without the adversely reduced efficiency. Turbines of this type are, however, highly complex, expensive, and susceptible to mechanical failure. Therefore, in particular in gas engines that are used to generate electricity, these turbines with variable turbine geometry are hardly economically feasible due to the therewith typically associated extended maintenance intervals.

What is needed in the art is a method for operating an internal combustion engine, a control unit for an internal combustion engine and an internal combustion engine wherein the aforementioned disadvantages are at least reduced, optionally do not occur.

### SUMMARY OF THE INVENTION

The invention relates to a method for operating an internal combustion engine, a control unit for an internal combustion engine and an internal combustion engine.

The present invention provides a method for operating an internal combustion engine, wherein an internal combustion engine has a compressor that is arranged in an air path in order to compress air—in particular intake ambient air surrounding the internal combustion engine—flowing along the air path, a turbine which is arranged in an exhaust gas path and which is drive-operatively connected with the compressor, and an electric motor. The electric motor is drive-operatively connected with the compressor. At least one operating parameter is collected that is characteristic for the density of the ambient air, especially in the area surrounding the internal combustion engine; and the electric motor is activated depending on the at least one operating parameter. By controlling the electric motor, the required boost pressure can be advantageously provided even at low air density, in that the compressor is driven with the electric motor in addition to the drive via the turbine. Thus, a boost pressure reserve that can be retrieved in a targeted manner as needed is provided by the electric motor. In contrast, at operating points where this is not necessary the additional drive by way of the electric motor can be omitted in that the electric motor is not motorically controlled, in particular, in that it is not activated. Since the turbine does not have to provide the required peak drive power alone, it can be sized to be larger, so that the internal combustion engine advantageously provides greater overall efficiency. In particular, the excessive boost pressure that occurs at many operating points in conventional designs is eliminated and consequently does not have to be regulated by the pressure control device. At the same time, the exhaust gas backpressure is reduced. In particular, there is no need to undersize the turbine in respect to the rated power of the internal combustion engine. In particular, the internal combustion engine operated within the scope of the method can have a high dynamic with boost pressure control reserve and at the same time be highly efficient.

Power control of the internal combustion engine is implemented in particular by way of the pressure regulating device that is arranged in the air path. The pressure regulating device is designed, in particular, as a throttle valve.

Within the scope of the method, the internal combustion engine is operated in particular with a fuel gas. In particular, the internal combustion engine is designed as a gas engine. The fuel gas can, in particular, be introduced into the air path upstream of the compressor. An ambient air/fuel gas mixture flows then in the air path to the compressor and is compressed by the compressor. Alternatively, or in addition, it is possible that the fuel gas is introduced directly into a combustion chamber of the internal combustion engine.

In the context of the present technical teaching, a fuel gas is understood to be in particular, a gaseous gas or gas mixture that is combustible at room temperature and ambient pressure, in particular at 25° C. and 1013 bar. In particular, natural gas, in particular liquified natural gas (LNG), in particular with variable hydrogen content or hydrogen is used.

A further development of the present invention provides that the electric motor is controlled to drive the compressor, if it is concluded based on the at least one operating parameter, that the density of the ambient air is less than a predetermined threshold density. In this way, in particular, control of the electric motor can advantageously occur in a targeted manner to provide the required boost pressure. The fact that the electric motor is controlled in order to drive the compressor means, in particular, that the electric motor is motorically controlled. In its capacity as an electric machine, it is additionally possible to control the electric motor—at other operating points—as a generator.

A further development of the present invention provides that the electric motor is at least not motorically controlled, in particular that it is not activated if it is concluded, based on the at least one operating parameter, that the density of the ambient air is at least consistent with the predetermined threshold density. The efficiency of the internal combustion engine is thus advantageously high, in particular under conditions where no additional drive to the compressor by way of the electric motor is required, and no energy for the latter is provided.

A further development of the present invention provides that the drive power of the electric motor is selected, depending on the at least one operating parameter. Thus, the drive power required for the provision of the necessary boost pressure can be provided advantageously in a targeted manner. In particular, no additional energy is used, which reflects advantageously on the efficiency of the internal combustion engine.

A further development of the present invention provides that at least one parameter is collected as the at least one operating parameter, wherein the at least one parameter is selected from a group consisting of: an actual power of the internal combustion engine, in particular compared to a target power of the internal combustion engine; an actual torque of the internal combustion engine, in particular compared to a target torque of the internal combustion engine; an ambient temperature of the internal combustion engine, and an ambient pressure of the internal combustion engine. In one embodiment, a combination of at least two, in particular more than two, of the parameters referred to herein are used as the at least one operating parameter. In particular, the herein referred to operating parameters are suitable for drawing conclusions in regard to the ambient temperature.

It is possible that the ambient pressure or the ambient temperature can be measured directly. It is, however, also possible, that at least one of these values is determined indirectly, in particular on the basis of another parameter or measured value, on the basis of which the appropriate value can be concluded. For example, at least one pressure value and/or temperature value can be measured along the air path—for example by way of a flow model—from which the ambient pressure and/or the ambient temperature can be concluded.

In particular, if the actual power of the internal combustion engine is lower than the target power, this can be seen as an indication that the required boost pressure will not be reached due to a low density of the ambient air. The same applies if the actual torque of the internal combustion engine is lower than the target torque. The ambient temperature, like the ambient pressure, is a direct indicator for the air density. If the various parameters are combined, the density of the ambient air can be concluded with greater accuracy, or the various parameters can be used for mutual plausibility checks.

A further development of the present invention provides that the drive power of the electric motor is selected depending on a control deviation in the power of the internal combustion engine. Thus, in particular, drive power can be allocated advantageously to the electric motor in a targeted and need-based manner to provide the required boost pressure. In the event of a negative control deviation, the electric motor is motorically controlled, in particular, it is activated, i.e., if the actual power is less than the target power of the internal combustion engine. In the event of a positive control deviation, the electric motor is not motorically controlled, in particular, it is not activated, if the actual power is greater than the target power of the internal combustion engine. In one embodiment, it is possible for the electric motor to be controlled as a generator—in other words, operated as a generator—if the actual power is greater than the target power of the internal combustion engine, in particular in order to increase the efficiency of the internal combustion engine or the electrical efficiency or the total electrical power of a genset, and/or to brake the compressor. Alternatively, or additionally, the electric motor is at least not motorically controlled, in particular, it is not activated, if the actual power corresponds exactly to the target power.

In the context of the present technical teaching, a control deviation is understood to mean a deviation from the actual value of an allocated target value.

Alternatively, or in addition, it is provided, that the drive power of the electric motor is selected depending on a control deviation of the torque of the internal combustion engine. Also in this way, drive power can be allocated to the electric motor in a targeted and need-based manner to provide the required boost pressure. In particular, in the event of a negative control deviation, the electric motor is activated, for example, if the actual torque is less than the target torque of the internal combustion engine. In particular, the electric motor is at least not motorically controlled in the event of a positive control deviation, in particular it is not activated, for example, if the actual torque is greater than the target torque of the internal combustion engine. However, also in this case—as described above—operation of the electric motor as a generator is possible. Alternatively, or additionally, the electric motor is not activated if the actual torque corresponds exactly to the target torque.

A further development of the present invention provides that the drive power of the electric motor is selected depending on an ambient pressure and an ambient temperature of the internal combustion engine. The combination of ambient pressure and ambient temperature, in particular, allows precise conclusions to be drawn in regard to the density of the ambient pressure.

In one embodiment the drive power of the electric motor is read from a characteristic map, depending on the ambient pressure and ambient temperature of the internal combustion engine. In particular, values for the drive power of the electric motor are stored in the characteristic map depending on the ambient pressure and ambient temperature values. This represents an especially simple and computationally non-intensive arrangement of the method.

A further development of the present invention provides that the electric motor is—motorically—controlled only if at least one additional condition is met, wherein the at least one additional condition is selected from a group consisting of: a load parameter of the internal combustion engine indicates a high momentary load, and a momentary compressor speed of the compressor is lower than a maximum compressor speed of the compressor. Advantageously, in this way, the compressor is only—motorically—controlled, if in fact there is a demand on the boost pressure reserve, and/or if it is at all possible, especially safely, to continue to run the compressor.

In the context of the present technical teaching, a high load is understood to mean especially a load which is greater than a predetermined load threshold value. The predetermined load threshold value can thereby depend on at least one additional parameter which, in turn, can be characteristic for the density of the ambient air. In particular, the predetermined load threshold value can be greater at higher density of the ambient air than at a lower density of the ambient air, and vice versa. The load threshold value can additionally or alternatively also depend on additional conditions which influence the load pressure, for example aging and wear and tear of the turbine or the compressor, the degree of contamination of an air filter, and optional additional parameters.

The parameter used as the load parameter is typically selected from a group consisting of: an opening position of the pressure regulating device, in particular the throttle valve; speed of the internal combustion engine; and a torque of the internal combustion engine. In one embodiment, the electric motor is only—motorically—controlled if the at least one additional condition is met in that the pressure regulating device is fully open, in particular in that the throttle valve which is arranged in the air path is fully open.

If the compressor has already reached its maximum compressor speed, it is potentially disadvantageous to operate the compressor in excess of said speed. In particular, this could lead to damage or even destruction of the compressor.

In one embodiment, the electric motor is only—motorically—controlled if both previously referenced additional conditions are—cumulatively—met.

The present invention also provides a control unit for an internal combustion engine which is designed to carry out a method according to the present invention, or a method according to one or a number of the previously described embodiments. In connection with the control unit, advantages arise, in particular, that were previously explained in connection with the method.

The present invention also provides an internal combustion engine, wherein the internal combustion engine has a compressor arranged in an air path of the internal combustion engine and is designed to compress ambient air flowing along the air path; a turbine which is drive-operatively connected to the compressor and is arranged in an exhaust gas path; an electric motor which is drive-operatively connected to the compressor; and a control unit, wherein the control unit is operatively connected to the electric motor and is designed to determine at least one operating parameter which is characteristic of a density of the ambient air of the internal combustion engine. The control unit is moreover designed to activate the electric motor depending on the at least one operating parameter. In particular, the internal combustion engine features a control unit according to the present invention or a control unit according to one or a number of the previously described embodiments. Advantages arise in particular in connection with the internal combustion engine, which were already described previously in connection with the method or the control unit.

The internal combustion engine has, in particular, a pressure control device that is arranged in the air path, in particular a throttle valve.

In one embodiment, the internal combustion engine is an internal combustion engine, operating with a fuel gas, in particular a gas engine. In one embodiment in particular, the internal combustion engine is connected to an electrical machine that can be operated as a generator. The present invention also includes an internal combustion engine arrangement which includes an internal combustion engine according to the present invention or an internal combustion engine according to one or a number of the embodiments described here and below, as well as an electrical machine which can be operated as a generator and which is drive-operatively connected to the internal combustion engine. The internal combustion engine arrangement is in particular a generator set or Genset.

In one embodiment, the control unit is operatively connected with at least one parameter sensor, in order to collect the at least one operating parameter by way of the parameter sensor. Alternatively, or in addition, the control unit is designed to determine, in particular to calculate, the at least one operating parameter, in particular from the other operating parameters or measured values. Alternatively, or in addition, the control unit is designed to obtain, in particular to calculate, the at least one operating parameter on the basis of a mathematical or physical model of the internal combustion engine. Alternatively, or in addition, the at least one operating parameter is known in the control unit.

A further development of the present invention provides that the internal combustion engine includes at least one parameter sensor that is operatively connected with the control unit and is designed to collect the at least one operating parameter. The at least one parameter sensor is selected, in particular, from a group consisting of: a speed sensor, a torque sensor, a pressure sensor, and a temperature sensor.

A further development of the present invention provides that the turbine is larger—in particular 5% to 10% larger—than a turbine of an internal combustion engine, whose control unit is not designed to control an electric motor subject to the at least one operating parameter, or which does not have such an electric motor. The turbine is larger, in particular, than the turbine of an internal combustion engine having the same rated power, whose control unit is not designed to activate the electric motor subject to the at least one operating parameter, or which does not have such an electric motor. The advantages already described are achieved, in particular, in this manner.

### BRIEF DESCRIPTION OF THE DRAWINGS

The above-mentioned and other features and advantages of this invention, and the

manner of attaining them, will become more apparent and the invention will be better understood by reference to the following description of embodiments of the invention taken in conjunction with the accompanying drawings, wherein:

FIG. 1 is a schematic representation of one design example of an internal combustion engine;

FIG. 2 is a schematic representation of one design example of a method for operating an internal combustion engine according to FIG. 1; and

FIG. 3 is a schematic representation of the operating principle of the internal combustion engine according to FIG. 1 and the method according to FIG. 2.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

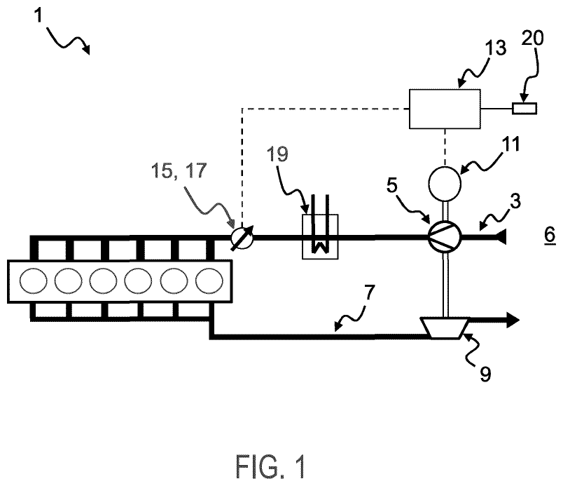

FIG. 1 is a schematic representation of one design example of an internal combustion engine 1.

Internal combustion engine 1 has an air path 3 and a compressor 5 arranged therein, wherein compressor 5 is arranged to compress ambient air flowing along air path 3 and drawn in from an environment 6 of internal combustion engine 1. In exhaust gas path 7, internal combustion engine 1 has a turbine 9 which is drive-operatively connected to compressor 5. In addition, internal combustion engine 1 has electric motor 11 that is drive-operatively connected to compressor 5, and a control unit 13 that is operatively connected—in particular via a converter that is not shown here—to electric motor 11. Control unit 13 is moreover arranged to determine at least one operating parameter that is characteristic for the density of the ambient air of internal combustion engine 1, in particular its density in environment 6. Control unit 13 is moreover arranged to activate electric motor 11 subject to the at least one operating parameter.

Internal combustion engine 1 has, in particular, a pressure control device 15 arranged in air path 3, which is optionally designed as a throttle valve 17. Pressure control device 15 is, in particular, operatively connected with control unit 13 and can be controlled by the latter in particular for implementation of power control or torque control of internal combustion engine 1. In addition, in the herein illustrated design example, a charge air cooler 19 is arranged in air path 3.

Internal combustion engine 1 has, in particular, at least one parameter sensor 20 which is operatively connected with control unit 13 and is arranged to collect the at least one operating parameter. In the herein illustrated design example, the at least one parameter sensor 20 is in particular a pressure sensor and/or a temperature sensor.

Internal combustion engine 1 is operated, in particular, with a fuel gas and is designed in particular as a gas engine.

Turbine 9 is designed larger, in particular, than a turbine of an internal combustion engine, having the same rated power, but whose control unit is not arranged to activate the electric motor subject to the at least one operating parameter, or which does not have such an electric motor. In particular, the turbine is 5% to 9% larger.

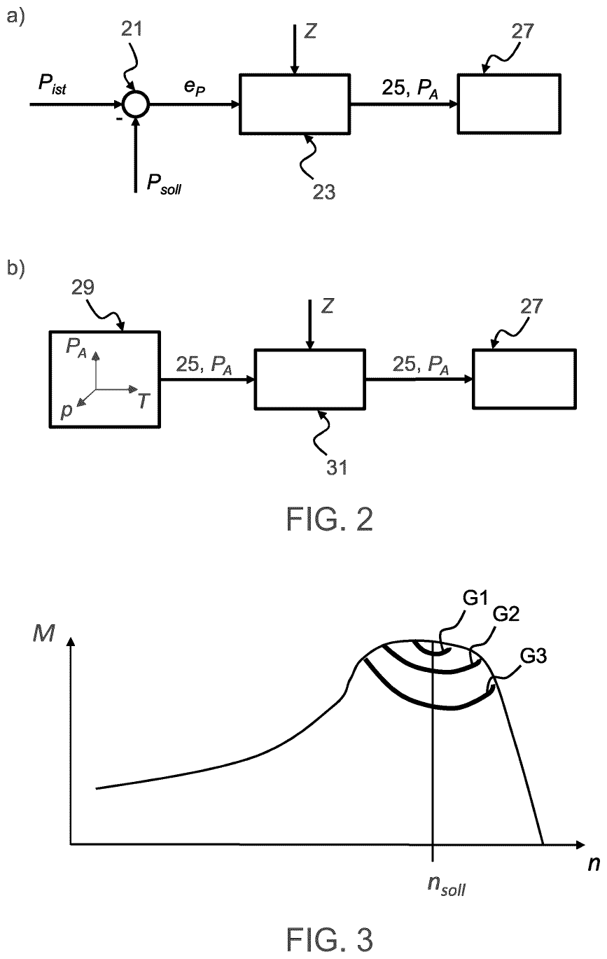

FIG. 2 is a schematic representation of design examples of a method for operating internal combustion engine 1 according to FIG. 1.

Identical and functionally identical elements are provided in all drawings with the same reference symbols; thus, reference is made respectively to preceding descriptions.

Section a) shows a first design example of the method, in which an actual power P_{actual}

of internal combustion engine 1 is detected as the at least one operating parameter. A target power P_{target} is subtracted from actual power P_{actual} in a comparison element 21, resulting in a power control deviation e_{P}, which is input into a computing element 23. Depending on power control deviation e_{P,}computing element 23 calculates a control variable 25—here in particular of a drive power P_{A} for electric motor 11—with which in particular a converter 27 that is electrically connected with electric motor 11 is controlled. Optionally, at least one additional condition Z is also input into computing element 23. In particular, control variable 25 is set to zero, in other words, electric motor 11 is not activated if the at least one additional condition Z is not met. In an optional embodiment, computing element 23 is a PID controller. Optionally, control variable 25 is also set to zero if power control deviation e_{P} is zero or positive.

In another embodiment, control variable 25 can be calculated depending on a torque control deviation of the torque of internal combustion engine 1, otherwise completely analogous to the representation shown here for the power.

In particular, control variable 25 is only calculated, or a value deviating from zero, in particular a positive value, is only assigned to control variable 25 if power control deviation e_{P} or torque control deviation e_{M} is negative, if a required target power P_{target} or if a required target torque is not currently delivered.

The at least one additional condition Z is selected, in particular from a group consisting of: a load parameter of internal combustion engine 1 indicates a high momentary load, and a momentary compressor speed of compressor 5 is lower than a maximum compressor speed. The parameter used as the load parameter is typically selected from a group consisting of: an opening position of pressure regulating device 15, in particular of throttle valve 17, a speed n of internal combustion engine 1, and a torque M of internal combustion engine 1.

Electric motor 11 is only activated if the at least one additional condition Z is met in that pressure regulating device 15 is fully open, in particular in that throttle valve 17 which is arranged in air path 3 is fully open.

In particular, electric motor 11 is only activated if both previously referenced additional conditions Z are—cumulatively—met.

A second design example of the method is shown under section b), wherein an ambient pressure p and an ambient temperature T of internal combustion engine 1 are used as the at least one operating parameter. In particular, control variable 25 for electric motor 11, in this case again, drive power P_{A}, is read out from a characteristic map 29 depending on the ambient pressure p and the ambient temperature T of internal combustion engine 1. Control variable 25 is passed via a logic element 31 to electric motor 11, in particular to converter 27, only if the at least one additional condition is met.

FIG. 3 is a schematic representation of the operational principle of internal combustion engine 1 according to FIG. 1 and the method according to FIG. 2.

It is shown, in particular, at which operating points of internal combustion engine 1 electric motor 11 is activated, that is, in particular, driven or respectively supplied with drive power P_{A}.

As already previously explained, the criterion used as at least one additional condition is whether a load parameter of internal combustion engine 1 indicates a high momentary load. Torque M or speed n of internal combustion engine 1 can be used in particular as the load parameter, but in particular also a combination of torque M and speed n. A high load is understood in particular to mean a load that is greater than a predetermined load threshold value. The predetermined load threshold value can thereby depend on at least one further parameter, which in particular can again be characteristic of the density of the ambient air. In particular, the predetermined load threshold value can be greater at a higher ambient air density than at a lower ambient air density, and vice versa.

FIG. 3 represents an operating state diagram of internal combustion engine 1, which is spanned by speed n plotted on the abscissa and torque M of internal combustion engine 1 plotted on the ordinate. Also shown are three limit curves G1, G2 and G3, which are used as load limit curves in the sense of the load threshold value. Above a respective current valid limit curve of the limit curves G1, G2, G3, the additional condition is met that the load parameter indicates a high momentary load, whereas below the currently valid limit curve G1, G2, G3, this additional condition is not met. Electric motor 11 is thus only driven if the operational state of internal combustion engine 1 is above the currently valid limit curve G1, G2, G3. If the operating state is exactly on the currently valid limit curve G1, G2, G3, electric motor 11 can either be driven or not driven, depending on the design of the method. As to which limit curve G1, G2, G3 is currently used as the valid limit curve G1, G2, G3 depends on the density of the ambient air, in particular on the ambient temperature and/or the ambient pressure. For example, at a low ambient temperature, first limit curve G1 can be used as the valid limit curve, whereas at a medium ambient temperature, second limit curve G2 is used as the valid limit curve, and at a high ambient temperature, third limit curve G3 is used as the valid limit curve. The lower the density of the ambient air—or, in the specific case described, the higher the ambient temperature—the wider the range in the operating state diagram within which electric motor 11 is controlled.

Which of the limit curves G1, G2, or G3 is used as the currently valid limit curve can, however, additionally or alternatively, depend on at least one other condition, such as aging or wear of the turbine or the compressor, the degree of contamination of an air filter, and optional other parameters that influence the boost pressure.

Target speed n_{target}, also shown in the diagram, refers to the specified speed at which internal combustion engine 1 is operated when it drives an electric synchronous machine in grid-parallel operation.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating an internal combustion engine, the method comprising the steps of:
providing that the internal combustion engine includes a compressor, a turbine, and an electric motor, the compressor being arranged in an air path so as to compress ambient air of the internal combustion engine flowing along the air path, the turbine being arranged in an exhaust gas path and being drive-operatively connected with the compressor, the electric motor being drive-operatively connected with the compressor;
collecting at least one operating parameter that is characteristic for a density of the ambient air of the internal combustion engine; and
controlling the electric motor depending on the at least one operating parameter.

2. The method according to claim 1, wherein the electric motor is controlled to drive the compressor if, based on the at least one operating parameter, the density of the ambient air is less than a predetermined threshold density.

3. The method according to claim 2, wherein the electric motor is at least not motor-controlled, if the at least one operating parameter indicates that the density of the ambient air corresponds at least to the predetermined threshold density.

4. The method according to claim 1, wherein a drive power of the electric motor is selected depending on the at least one operating parameter.

5. The method according to claim 1, wherein the at least one parameter is collected, wherein the at least one parameter is selected from a group consisting of: an actual power of the internal combustion engine; an actual torque of the internal combustion engine; an ambient temperature of the internal combustion engine; and an ambient pressure of the internal combustion engine.

6. The method according to claim 1, wherein a combination of parameters-which includes the at least one parameter—are collected, wherein the at least one parameter is selected from a group consisting of: an actual power of the internal combustion engine compared to a target power of the internal combustion engine; an actual torque of the internal combustion engine compared to a target torque of the internal combustion engine; an ambient temperature of the internal combustion engine; and an ambient pressure of the internal combustion engine.

7. The method according to claim 1, wherein a drive power of the electric motor is selected depending on a control deviation in a power or a torque of the internal combustion engine.

8. The method according to claim 1, wherein a drive power of the electric motor is selected depending on an ambient pressure of the internal combustion engine and an ambient temperature of the internal combustion engine.

9. The method according to claim 8, wherein a drive power of the electric motor is read from a characteristic map.

10. The method according to claim 1, wherein the electric motor is only activated if at least one additional condition is met, wherein the at least one additional condition is selected from a group consisting of: a load parameter of the internal combustion engine indicates a high momentary load; and a momentary compressor speed of the compressor is lower than a maximum compressor speed of the compressor.

11. A control unit for an internal combustion engine, comprising the steps of:
the control unit, which is configured for carrying out a method for operating the internal combustion engine, the method including the steps of:
providing that the internal combustion engine includes a compressor, a turbine, and an electric motor, the compressor being arranged in an air path so as to compress ambient air of the internal combustion engine flowing along the air path, the turbine being arranged in an exhaust gas path and being drive-operatively connected with the compressor, the electric motor being drive-operatively connected with the compressor;
collecting at least one operating parameter that is characteristic for a density of the ambient air of the internal combustion engine; and
controlling the electric motor depending on the at least one operating parameter.

12. An internal combustion engine, comprising:
an air path;
a compressor, which is arranged in the air path of the internal combustion engine and is configured for compressing ambient air flowing along the air path;
an exhaust gas path;
a turbine, which is drive-operatively connected to the compressor and is arranged in the exhaust gas path;
an electric motor which is drive-operatively connected to the compressor; and
a control unit, which is operatively connected with the electric motor and is configured for determining at least one operating parameter that is characteristic of a density of the ambient air of the internal combustion engine, the control unit being further configured for activating the electric motor depending on the at least one operating parameter.

13. The internal combustion engine according to claim 12, wherein the internal combustion engine further includes at least one parameter sensor that is operatively connected with the control unit and is configured for collecting the at least one operating parameter.

14. The internal combustion engine according to claim 12, wherein the turbine is larger than a turbine of an internal combustion engine (a) whose control unit is not configured to control an electric motor dependent on the at least one operating parameter or (b) which does not have such an electric motor.

15. The internal combustion engine according to claim 12, wherein the turbine is 5% to 10% larger than a turbine of an internal combustion engine (a) whose control unit is not configured to control an electric motor dependent on the at least one operating parameter or (b) which does not have such an electric motor.
